(19) United States
(12) Patent Application Publication
(10) Pub. No.: US 2009/0014116 A1
(43) Pub. Date: Jan. 15, 2009

(54) METHOD OF PRODUCING RESIN SHEET

(75) Inventors: Katsuhiko Takada, Shizuoka (JP); Takahiro Hayashi, Shizuoka (JP); Takekazu Yamamoto, Shizuoka (JP); Yasuyuki Hara, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/908,919

(22) PCT Filed: Mar. 15, 2006
(86) PCT No.: PCT/JP2006/305617

§ 371 Date: Sep. 17, 2007

(30) Foreign Application Priority Data
Mar. 16, 2005 (JP) 2005-075687

(51) Int. Cl. B29C 59/04

(52) U.S. Cl. 156/209

(57) ABSTRACT

A method of producing a resin sheet particularly suitably used for a light guide plate positioned on the backside of various display devices or various optical devices, which can give a desired cross-sectional shape when producing a resin sheet with a wide thickness distribution in the width direction upon molding is provided. A sheet-shaped resin material extruded from a die and a backup sheet fed to one side of the resin material are pressed by an emboss roller and a nip roller positioned against the emboss roller in such a manner that the resin material is on the side of the emboss roller and the backup sheet is on the side of the nip roller, thereby transferring projections and depressions on the surface of the emboss roller to the resin material, and the laminate of the resin material and the backup sheet after transfer is wound on a releasing roller positioned against the emboss roller to be released from the emboss roller.

### TECHNICAL FIELD

The present invention relates to a method of producing a resin sheet, more specifically to a method of producing a resin sheet suitably used for a light guide plate positioned on the backside of various display devices or various optical devices.

### BACKGROUND ART

Referring to resin sheets used in various optical devices, Fresnel lenses and lenticular lenses are used in a wide variety of fields. These resin sheets have patterned projections and depressions on the surface, and due to such projections and depressions, Fresnel lenses and lenticular lenses exhibit their optical properties.

Regarding the method of producing such resin sheets, various proposals have been made so far (see Patent Documents 1 to 4). In all of these techniques, roll forming is employed in order to improve productivity.

For example, in Patent Document 1, transferability has been improved by making special arrangement for cooling device before releasing a resin sheet from a roller. Patent Document 2 discloses a method of producing a Fresnel lens using a roller around which a die is wound.

In Patent Document 3, a heat buffer is put inside a forming roll to improve productivity and transferability. In Patent Document 4, corona discharge is employed so as to improve transferability and reduce defects.

In these conventional arts, a typical roll forming technique employs a configuration illustrated in FIG. 6. The apparatus comprises a die 2 for sheet which forms a resin material 1 melted in an extruder (not shown) into a sheet, a stamper roller 3 having projections and depressions on the surface, a mirror finished roller 4 positioned against the stamper roller 3, and a mirror finished roller for releasing 5 faced with the stamper roller 3 and positioned on the opposite side of the mirror finished roller 4.

The sheet-shaped resin material 1 extruded from the die 2 is pressed by the stamper roller 3 and the mirror finished roller 4 to transfer the projections and depressions on the surface of the stamper roller 3 to the resin material 1, and the resin material 1 is then wound on the mirror finished roller for releasing 5 to be released from the stamper roller 3.

[Patent Document 1] Japanese Patent Application Laid-Open No. 8-31025

[Patent Document 2] Japanese Patent Application Laid-Open No. 7-314567

[Patent Document 3] Japanese Patent Application Laid-Open No. 2003-53834

[Patent Document 4] Japanese Patent Application Laid-Open No. 8-287530

### DISCLOSURE OF THE INVENTION

### Problems to be Solved by the Invention

The above-described techniques, however, all relate to a method of producing a relatively thin resin sheet, and thus are not suitable for producing a relatively thick resin sheet. In particular, when a resin sheet with a wide thickness distribution in the width direction upon molding is produced, the desired cross-sectional shape is difficult to obtain.

For instance, when PMMA (polymethyl methacrylate resin) is subjected to roll forming after extrusion and thickness distribution is given in the width direction to create a difference in thickness between the thickest part and the thinnest part of 1 mm or more, the resulting sheet has problems that the surface or the other surface of the sheet becomes uneven (shrinkage cavity generated by shrinkage of resin upon curing, elastic recovery distribution), the entire transfer rate of surface profile is decreased and that sharp edge forms cannot be transferred.

The present invention has been made in view of such circumstances and aims at providing a method of producing a resin sheet particularly suitably used for a light guide plate positioned on the backside of various display devices or various optical devices, which can give the desired cross-sectional shape when a resin sheet with a wide thickness distribution in the width direction upon molding is produced.

### Means for Solving the Problem

To accomplish the aforementioned object, the present invention provides a method of producing a resin sheet, comprising the steps of:

pressing a sheet-shaped resin material extruded from a die and a backup sheet fed to one side of the resin material by an emboss roller and a nip roller positioned against the emboss roller in such a manner that the resin material is on the side of the emboss roller and the backup sheet is on the side of the nip roller,

transferring projections and depressions on the surface of the emboss roller to the resin material, and

winding a laminate of the resin material and the backup sheet after transfer on a releasing roller positioned against the emboss roller to release the laminate from the emboss roller.

According to the present invention, a laminate of a sheet-shaped resin material and a backup sheet is pressed by an emboss roller and a nip roller, thereby transferring projections and depressions to the resin material, and the laminate is wound on a releasing roller to be released from the emboss roller. Because the backside of the resin material is supported by the backup sheet as described above, unevenness on the backside produced immediately after molding is hardly generated, and since deformation in the downstream is suppressed by cooling or fixing at an early stage immediately after molding, the desired cross-sectional shape can be obtained even in the case of a resin sheet with a wide thickness distribution in the width direction upon molding.

In the present invention, it is preferred that the projections and depressions transferred to the resin material create a difference in thickness in the width direction between the thickest part and the thinnest part of the resin material of 1 mm or more. In the present invention, it is also preferred that the resin material has a thickness of 5 mm or less at the thinnest part. As described above, the present invention has an advantage in forming a cross-sectional shape of a resin material which has been difficult to mold.

In the present invention, the backup sheet is preferably a resin sheet having a glass transition temperature Tg₁ which is higher than the glass transition temperature Tg₂ of the resin material. When the thermal deformation of the backup sheet is smaller than that of the resin material as described above, advantages of the present invention can be effected.

The “glass transition temperature Tg” refers to a temperature at which an organic polymer material shifts to high temperature supercooled liquid or rubber-like substances from a low temperature glass state.

In the present invention, it is preferred that the backup sheet has a modulus of longitudinal elasticity of 1×10⁹ N/m² or more when used. When the backup sheet has a modulus of longitudinal elasticity (so-called Young's modulus) in an appropriate range as herein described, excessive deformation of resin material can be prevented due to the rigidity of the backup sheet, whereby advantages of the present invention can be effected.

In the present invention, the backup sheet has a thickness of preferably 0.01 to 1.0 mm. A backup sheet having such a thickness provides appropriate flexibility and rigidity, whereby advantages of the present invention can be exhibited.

In the present invention, it is preferred that the backup sheet is peeled off from the resin material after releasing the laminate of the resin material and the backup sheet after transfer from the emboss roller, or on the emboss roller. In this case, the backup sheet is peeled off from the resin material after transfer, so it becomes easier to handle the product resin material.

In the present invention, it is preferred that the backup sheet peeled off from the resin material is subjected to cleaning. Such cleaning of the backup sheet after peeling is advantageous when reusing the backup sheet.

In the present invention, it is preferred that a sheet feeding device for continuously feeding the backup sheet and a sheet winding device for accepting the backup sheet are provided. Since such a sheet feeding device and a sheet winding device are provided, handling of the backup sheet becomes very easy.

In the present invention, it is preferred that the backup sheet has projections and depressions on substantially the entire surface contacting the resin material and the projections and depressions are transferred to the resin material. When projections and depressions formed by, for example, embossing, brushing, blasting or peening, or prism-shaped projections and depressions, are formed on substantially the entire surface of the backup sheet contacting the resin material as herein described, a reversed form thereof can be formed on the backside of the resin material.

### EFFECTS OF THE INVENTION

As described above, according to the present invention, the desired cross-sectional shape can be obtained even in the case of a resin sheet with a wide thickness distribution in the width direction upon molding.

### BRIEF DESCRIPTION OF THE DRAWINGS

FIG. 1 is a structure view illustrating an example of production line for a resin sheet to which the present invention is applied;

FIG. 2 is a perspective view illustrating a linearly cut edge of a resin material after molding;

FIG. 3 is a perspective view illustrating a linearly cut edge of a resin material after molding;

FIG. 4 is a structure view illustrating another example of production line for a resin sheet to which the present invention is applied;

FIG. 5 is a structure view illustrating still another example of production line for a resin sheet to which the present invention is applied; and

FIG. 6 is a structure view illustrating an example of conventional production line for a resin sheet.

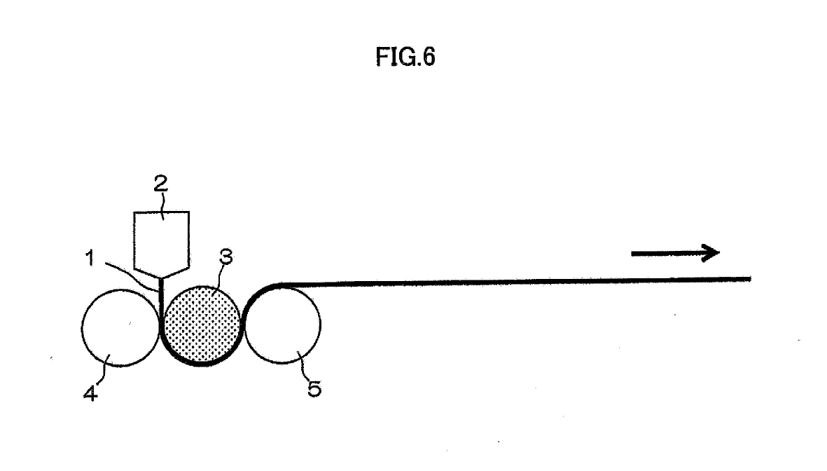

### DESCRIPTION OF SYMBOLS

10, 10′ . . . production line for resin sheet, 12 . . . die, 14 . . . resin material, 16 . . . emboss roller, 18 . . . nip roller, 18A, 18B, 18C . . . nip roller, 20 . . . backup sheet, 22 . . . guide roller, 24 releasing roller, 26 . . . sheet feeding device, 28 . . . sheet winding device, 30 gradual cooling zone, 32 . . . peeling part, 34 . . . dancer roller, 36 . . . driving roller, 38, 40 . . . cooling device

### BEST MODE FOR CARRYING OUT THE INVENTION

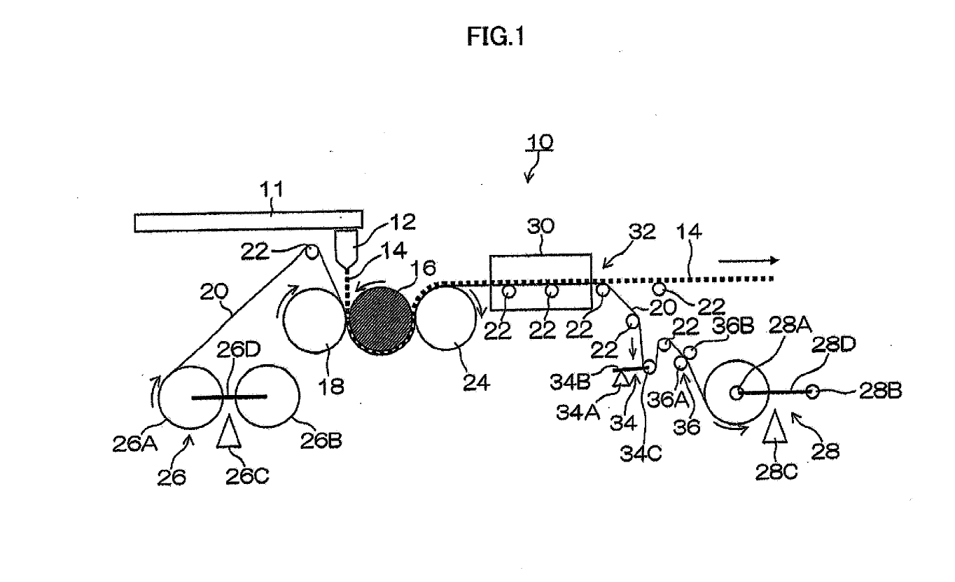

In the following, a preferred embodiment of the method of producing a resin sheet of the present invention (first embodiment) is described in detail with reference to the attached figures. FIG. 1 is a schematic view illustrating an example of production line for a resin sheet to which the method of producing a resin sheet of the present invention is applied.

The production line 10 for a resin sheet is composed of a die 12 for sheet for forming a resin material 14 melted in an extruder 11 into a sheet, an emboss roller 16 having projections and depressions on the surface, a nip roller 18 positioned against the emboss roller 16, a releasing roller 24 positioned against the emboss roller 16, a sheet feeding device 26 for continuously feeding the backup sheet 20, a sheet winding device 28 for collecting the backup sheet 20, and a plurality of guide rollers 22, 22 . . . which support transfer of the resin material 14 and the backup sheet 20.

The slit size of the die 12 is designed so that the extruded molten resin material 14 is wider than the emboss of the emboss roller 16, and positioned so that the molten resin material 14 from the die 12 is extruded into an area between the emboss roller 16 and the nip roller 18.

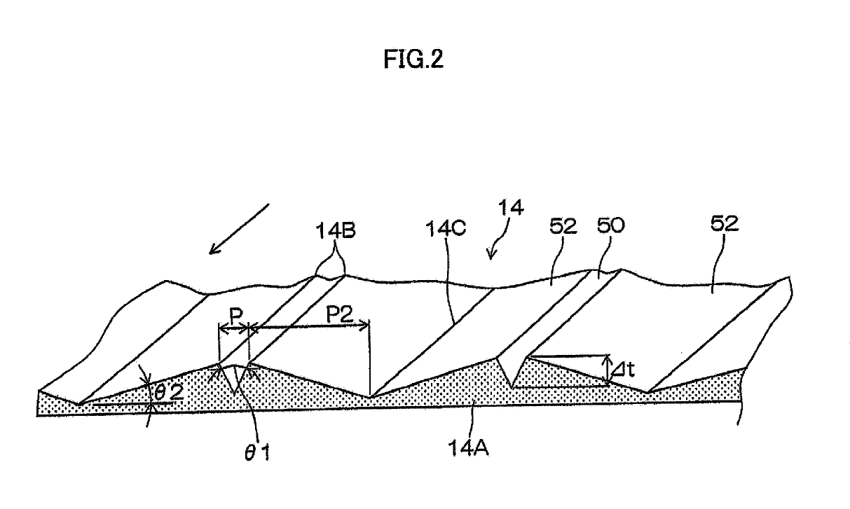

The emboss roller 16 has patterned projections and depressions on its surface. The patterned projections and depressions may have a shape opposite from the shape of, for example, the resin material 14 after molding shown in FIG. 2. FIG. 2 is a perspective view illustrating a linearly cut edge 14A of the resin material 14 after molding.

Specifically, the resin material 14 has a flat backside, and a linear projection and depression pattern parallel to the arrow is formed on the surface of the resin material 14. The arrow indicates the traveling direction of the resin material 14. Thus, an endless groove having a shape opposite from the shape of the edge 14A may be formed on the surface of the emboss roller 16. The projection and depression pattern on the surface of the resin material 14 will be described in detail later.

Referring to the material of the emboss roller 16, useful are various steel members, stainless steel, copper, zinc, brass, materials having a core made of such metal and rubber-lined on the surface, those metal materials plated with HCr, Cu or Ni, ceramics and various composite materials.

Regarding the method of forming projection and depression patterns on the surface of the emboss roller 16, combination of cutting with an NC lathe and buffing finish is generally preferably adopted, although the method depends on pitches and depths of projection and depression patterns or the material of the surface of the emboss roller 16. Other known processing such as grinding, ultrasonic machining, electrical discharge machining may also be employed.

The surface of the emboss roller 16 has a surface roughness Ra of preferably 0.5 μm or less, more preferably 0.2 μm or less.

The emboss roller 16 is rotatably driven in the direction of the arrow in FIG. 1 by an unrepresented driving member at a pre-determined peripheral speed. The emboss roller 16 is also equipped with a temperature control device. Such a temperature control device can control and prevent temperature increase of the emboss roller 16 due to the resin material 14 heated to high temperatures, or sharp drop in the temperature of the roller.

For such a temperature control device, a configuration in which temperature controlled oil is circulated inside the roller is preferably adopted. The oil can be supplied and discharged by means of a configuration in which a rotary joint is put to the end of the roller. This temperature control device is used in the production line 10 for a resin sheet of FIG. 1.

The nip roller 18 is positioned against the emboss roller 16 and presses the resin material 14 and the backup sheet 20 stacked on the backside thereof with the emboss roller 16, and is disposed at the same height as the emboss roller 16 in the upstream in the traveling direction.

It is preferred that the surface of the nip roller 18 is mirror finished. Such a surface makes the backside of the resin material 14 after molding in good condition. The surface of the nip roller 18 has a surface roughness Ra of preferably 0.5 μm or less, more preferably 0.2 μm or less.

Referring to the material of the nip roller 18, useful are various steel members, stainless steel, copper, zinc, brass, materials having a core made of such metal and rubber-lined on the surface, those metal materials plated with HCr, Cu or Ni, ceramics and various composite materials.

The nip roller 18 is rotatably driven in the direction of the arrow in FIG. 1 by an unrepresented driving member at a pre-determined peripheral speed. A configuration in which no driving member is attached to the nip roller 18 is also possible, but to make the backside of the resin material 14 in good condition, it is preferred to attach a driving member.

The nip roller 18 is equipped with a pressurizing device (not shown) so as to press the resin material 14 present between the nip roller 18 and the emboss roller 16 at a pre-determined pressure. The pressurizing device applies pressure in the direction of the normal line at the contact point of the nip roller 18 and the emboss roller 16, and known device such as a motor driving device, an air cylinder or a hydraulic cylinder may be used.

For the nip roller 18, a configuration in which deflection due to the reaction force to the pressing force is hardly generated may also be employed. For such a configuration, a configuration in which a back-up roller is provided behind the nip roller 18 (opposite side from the emboss roller 16), a configuration employing a crown form (wider at the center), a configuration which has a strength distribution so that the roller has a greater rigidity at the center in the roller axis direction, or a combination thereof may be adopted.

The nip roller 18 has a temperature control device. An optimal preset temperature of the nip roller 18 is selected based on the material of the resin material 14, the temperature of the resin material 14 upon melting (e.g., at the slit exit of the die 12), the transfer rate of the resin material 14, the outer diameter of the emboss roller 16 and the projection and depression pattern of the emboss roller 16.

For the temperature control device of the nip roller 18, a configuration in which temperature controlled oil is circulated inside the roller is preferably adopted. The oil can be supplied and discharged by means of a configuration in which a rotary joint is put to the end of the roller. This temperature control device is used in the production line 10 for a resin sheet of FIG. 1.

Regarding other temperature control device, known device such as a sheath heater embedded inside the roller and a dielectric heating device disposed in the vicinity of the roller may be used.

For the backup sheet 20, resin films and metal foils (aluminum web, iron, stainless steel, copper, brass, zinc, etc.) may be used. As the material of the resin film, known materials such as polyethylene, polypropylene, polyvinyl chloride, polyvinylidene chloride, polyvinyl acetate, polystyrene, polycarbonate, polyamide, PET (polyethylene terephthalate), biaxially oriented polyethylene terephthalate, polyethylene naphthalate, polyamideimide, polyimide, aromatic polyamide, cellulose triacetate, cellulose acetate propionate and cellulose diacetate may be used. Of these, polyethylene terephthalate, polyethylene naphthalate and polyamide are particularly preferably used.

As described earlier, it is preferred that the backup sheet 20 has a glass transition temperature Tg₁ higher than the glass transition temperature Tg₂ of the resin material 14. When the thermal deformation of the backup sheet 20 is smaller than that of the resin material 14 as described above, deformation of the backup sheet 20 can be prevented, whereby advantages of the present invention can be exhibited.

Further, as described earlier, it is preferred that the backup sheet 20 has a modulus of longitudinal elasticity of 1×10⁹ N/m² or more when used. When the backup sheet 20 has a modulus of longitudinal elasticity (so-called Young's modulus) in an appropriate range, excessive deformation of resin material 14 can be prevented due to the rigidity of the backup sheet 20, whereby advantages of the present invention can be exhibited.

Further, as described earlier, it is preferred that the backup sheet 20 has a thickness of 0.5 to 100 μm. A backup sheet 20 having such a thickness provides moderate flexibility and rigidity, whereby advantages of the present invention can be exhibited.

With respect to the width of the backup sheet 20, it is preferred that the backup sheet has substantially the same width as the resin material 14. With respect to the length of the backup sheet, a backup sheet 1000 to 100000 m in length is generally used. However, sizes other than these may also be employed.

These backup sheets 20 may be previously subjected to corona discharge, plasma treatment, adhesion improvement, heat treatment or dust removal. The backup sheet 20 has a surface roughness Ra of preferably 3 to 10 nm at a cut-off value of 0.25 mm.

Projections and depressions formed by, for example, embossing, brushing, blasting or peening, or prism-shaped projections and depressions may be formed on substantially the entire surface of the backup sheet 20 contacting the resin material 14. With this, a reversed form thereof can be formed on the backside of the resin material.

The sheet feeding device 26 continuously sends out the backup sheet 20, and a web roll 26A sending out the backup sheet 20 around which the backup sheet 20 is wound and a new (spare) web roll 26B are disposed on both ends of a support arm 26D. By the rotation of the support arm 26D with the support point 26C as a rotational center, the web roll 26A sending out the backup sheet 20 can be replaced with the new (spare) web roll 26B while continuously transferring the backup sheet 20.

The backup sheet 20 fed from the sheet feeding device 26 is supplied on the backside of the resin material 14 through a guide roller 22 and transferred to the area between the emboss roller 16 and the nip roller 18.

The releasing roller 24 is positioned against the emboss roller 16, on which a laminate of the resin material 14 and the backup sheet 20 is wound to release the resin material 14 from the emboss roller 16. The releasing roller 24 is disposed at 180 degrees in the downstream of the nip roller 18 across the emboss roller 16. Regarding the position of the releasing roller 24, modes other than the above are available.

It is preferred that the surface of the releasing roller 24 is mirror finished. Such a surface makes the backside of the resin material 14 after molding in good condition. The surface of the releasing roller 24 has a surface roughness Ra of preferably 0.5 μm or less, more preferably 0.2 μm or less.

As the material of the releasing roller 24, various steel members, stainless steel, copper, zinc, brass, materials having a core made of such metal and rubber-lined on the surface, those metal materials plated with HCr, Cu or Ni, ceramics and various composite materials may be employed.

The releasing roller 24 is rotatably driven in the direction of the arrow in FIG. 1 by a driving device (not shown) at a pre-determined peripheral speed. A configuration in which no driving device is attached to the releasing roller 24 is also possible, but to make the surface of the resin material 14 in good condition, it is preferred to attach a driving device.

The releasing roller 24 is equipped with a temperature controlling device. By adjusting to an appropriate preset temperature, projections and depressions can be formed in good condition on the surface of the resin material 14.

It is preferred that in order to monitor the surface temperature at some parts of the rollers and the resin material 14 described above, a surface temperature measuring device (not shown) is provided. For such a surface temperature measuring device, various known measuring device such as an infrared thermometer and a radiation thermometer may be employed.

The surface temperature measuring device measures the surface temperature at, for example, several points in the width direction of the resin material 14 present between the die 12 and the emboss roller 16, several points in the width direction of the resin material 14 immediately following the releasing roller 24, or several points in the width direction of the resin material 14 wound on the emboss roller 16 or the releasing roller 24 (opposite side of the roller).

It is also possible to send the results monitored by the surface temperature measuring device to the temperature control device of the rollers and the die 12 as feedback so as to reflect the results in temperature control of the rollers. Alternatively, operation with feedforward control without a surface temperature measuring device is also available.

It is also preferable to adopt a tension detecting device for detecting the tension of the resin material 14 or a thickness detecting device for detecting the thickness of the resin material 14 (thickness sensor) in the production line 10 for a resin sheet shown in FIG. 1 or in the downstream thereof. The detection result in such detecting device may be compared with the preset value and sent to the draw control (second embodiment) described later as feedback.

A gradual cooling zone 30 (or annealing zone) is provided so as to prevent rapid temperature change of the resin material 14 in the downstream of the releasing roller 24. When the resin material 14 undergoes rapid temperature change, the inside of the resin material 14, for example, remains plastic, while the surface and its neighboring area are already elastic, and due to shrinkage caused by curing in the inside, the surface profile of the resin material 14 is deteriorated. Further, the resin material 14 may be warped due to difference in temperature between the surface and the backside of the resin material 14.

The gradual cooling zone 30 may be formed like a tunnel in the horizontal direction, and a configuration in which a temperature control device is provided in the tunnel so as to control the cooling temperature profile of the resin material 14 may be adopted. For the temperature control device, known device such as device configure to supply temperature controlled air (hot air or cold air) to the resin material 14 through a plurality of nozzles or device configured to heat both sides of the resin material 14 by a heating device (a nichrome wire heater, an infrared heater, a dielectric heating device, etc.) may be employed.

In the downstream of the gradual cooling zone 30 (or annealing zone), a peeling part 32 is disposed. In the peeling part 32, the resin material 14 is held by guide rollers 22, 22 . . . and transferred straight to the right, and the backup sheet 20 is held by guide rollers 22, 22 . . . and transferred to the lower right.

When the backup sheet 20 is peeled off from the resin material 14 at the peeling part 32 as herein described, it becomes easier to handle the product resin material 14.

In the downstream of the peeling part 32, a washing unit (washing zone), a defect inspection unit (inspection zone), a lamination unit, a side cutter, a cross cutter and a collecting space (not shown) are provided in that order with respect to the resin material 14.

Of these, the lamination unit is for bonding a protective film (polyethylene film, etc.) to both sides of the resin material 14. The side cutter cuts both edges in the width direction (waste portions) of the resin material 14, and the cross cutter cuts the resin material 14 evenly into a pre-determined length.

Some of the above units may be omitted depending on the purpose.

In the downstream of the peeling part 32, a dancer roller 34, a cleaning device (not shown), a driving roller 36 and a sheet winding device 28 are provided in sequence for the backup sheet 20.

Of these, the dancer roller 34 adjusts the tension of the backup sheet 20, and is composed of a rotational support 34A, a rotational arm 34B held by the rotational support 34A at one end, and a roller 34C held on the other end of the rotational arm 34B. By urging the rotational arm 34B in the direction of the arrow in the figure, the tension of the backup sheet 20 can be controlled.

The cleaning device removes contaminants such as dust deposited on the surface of the backup sheet 20, and various known device such as a device for pressing a cleaning tape or a cleaning roller to the backup sheet 20 or a device for spraying destaticized clean air (possibly nitrogen gas, etc.) to the backup sheet 20 may be adopted.

The driving roller 36 is a mechanism for transferring the backup sheet 20 while sandwiching (nipping) the backup sheet 20 by a roller 36A and a roller 36B, in which at least one of the roller 36A and the roller 36B is rotatably driven.

The sheet winding device 28 accepts the backup sheet 20. A winding core 28A collecting the backup sheet 20 around which the backup sheet 20 is wound and a new (spare) winding core 28B are disposed on both ends of a support arm 28D. By the rotation of the support arm 28D with the support point 28C as a rotational center, the winding core 28A collecting the backup sheet 20 can be replaced with the new (spare) winding core 28B while continuously transferring the backup sheet 20.

The method of producing a resin sheet on the production line 10 for a resin sheet shown in FIG. 1 is now described.

The resin material 14 used in the present invention may be a thermoplastic resin, and examples thereof include polymethyl methacrylate resin (PMMA), polycarbonate resin, polystyrene resin, MS resin, AS resin, polypropylene resin, polyethylene resin, polyethylene terephthalate resin, polyvinyl chloride resin (PVC), thermoplastic elastomers, copolymers thereof and cycloolefin polymers.

A laminate of the sheet-shaped resin material 14 extruded from the die 12 and the backup sheet 20 fed from the sheet feeding device 26 and supplied on the backside of the resin material 14 is pressed by the emboss roller 16 and the nip roller 18 positioned against the emboss roller 16, thereby transferring projections and depressions on the surface of the emboss roller 16 to the resin material 14, and the laminate of the resin material 14 and the backup sheet 20 is wound on the releasing roller 24 positioned against the emboss roller 16 to be released from the emboss roller 16.

The resin material 14 (laminate with the backup sheet 20) released from the emboss roller 16 is transferred in the horizontal direction, gradually cooled while passing through the gradual cooling zone 30, and when strain is removed, the backup sheet 20 is separated at the peeling part 32, and the resin material 14 is cut into a pre-determined length and stored as resin sheet products in a product collecting zone in the downstream.

On the other hand, contaminants on the backup sheet 20 separated from the resin material 14 in the peeling part 32 are removed by a cleaning device and the backup sheet 20 is wound and collected on the winding core 28A of the sheet winding device 28. The backup sheet 20 wound around the winding core 28A is reusable.

In the production of the resin sheet 14, the extrusion rate of the resin material 14 from the die 12 may be 0.1 to 50 m/minute, preferably 0.3 to 30 m/minute. Accordingly, the peripheral speed of the emboss roller 16, the peripheral speed of the nip roller 18 and the transfer speed of the backup sheet 20 are substantially consistent with the above rate.

It is preferred that the fluctuation in the rate of the rollers is controlled to within 1% relative to the preset value.

The pressure from the nip roller 18 applied to the emboss roller 16 is preferably 0 to 200 kN/m (0 to 200 kgf/cm), more preferably 0 to 100 kN/m (0 to 100 kgf/cm) on a line pressure basis (value converted assuming the plane contact of nip rollers due to elastic deformation to be line contact).

It is preferred that the temperature of the nip roller 18 and the releasing roller 24 is individually controlled. It is also preferred that the temperature of the resin material 14 on the releasing roller 24 is not higher than the softening point Ta of the resin. When polymethyl methacrylate resin is used as the resin material 14, the preset temperature of the releasing roller 24 may be 50 to 110° C.

Next, the projection and depression pattern on the surface of the resin material 14 is described in detail. As described above, FIG. 2 is a perspective view illustrating a linearly cut edge 14A of the resin material 14 after molding. The resin material 14 has a flat backside.

The projection and depression pattern on resin material 14 is an projection and depression pattern linearly extended in the longitudinal direction (the direction shown by the arrow in the figure). This pattern has a repetition of a V-groove 50 formed on the thickest part 14B of the resin material 14 and taper portions 52, 52 whose thickness is linearly reduced toward the thinnest part 14C of the resin material 14 from both edges of the V-groove 50. In other words, the pattern has a continuous profile of a unit (1 pitch) of the V-groove 50 and the taper portions 52, 52 on both sides, which is axisymmetric to the center line of the V-groove 50.

Referring to FIG. 2, the thinnest part 14C in the resin material 14 has a thickness of preferably 5 mm or less, more preferably between 0.5 mm or more and 2 mm or less. The difference in thickness between the thickest part 14B and the thinnest part 14C of the resin material 14 is preferably 1 mm or more, more preferably 2.5 mm or more. With such a size, the laminate can be suitably used for a light guide plate positioned on the backside of various display devices or various optical devices.

When the resin material 14 after molding is used for a light guide plate, a cylindrical cold-cathode tube is put inside the V-groove 50, and the light emitted from the cold-cathode tube enters the resin material 14 through the surface of the V-groove 50, reflected on the taper portions 52, 52 and irradiated through the backside of the resin material 14 in a planar form.

When the resin material 14 after molding is used for a light guide plate as described above, the V-groove 50 has a width p of preferably 2 mm or more, and an apex angle θ1 of preferably 40 to 80 degrees. The V-groove 50 has a depth Δt of preferably 1 mm or more, further preferably 2.5 mm or more. The taper portions 52, 52 has a tilt angle θ2 of preferably 3 to 20 degrees and a width p2 of preferably 5 mm or more, further preferably 10 mm or more.

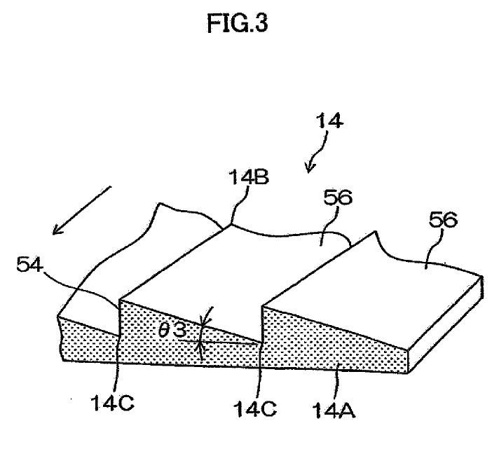

Next, another projection and depression pattern on the surface of the resin material 14 is described. FIG. 3 is a perspective view illustrating a linearly cut edge 14A of the resin material 14 after molding. The resin material 14 has a flat backside.

The projection and depression pattern on the surface of the resin material 14 is an projection and depression pattern linearly extended in the longitudinal direction (the direction shown by the arrow in the figure). This pattern having a saw-tooth shaped cross section has a repetition of a vertical wall 54 connecting the thickest part 14B and the thinnest part 14C of the resin material 14 and a taper portion 56 whose thickness is linearly reduced toward the thinnest part 14C of the resin material 14 from the upper edge (thickest part 14B) of the vertical wall 54.

Referring to FIG. 3, the thinnest part 14C of the resin material 14 has a thickness of 5 mm or less, more preferably between 0.5 mm or more and 2 mm or less. The difference in thickness between the thickest part 14B and the thinnest part 14C of the resin material 14 is preferably 1 mm or more, more preferably 2.5 mm or more. With such a size, the resin material 14 can be suitably used for a light guide plate positioned on the backside of various display devices or various optical devices.

When the resin material 14 after molding is used for a light guide plate, a cylindrical cold-cathode tube is put to the side face of the vertical wall 54 and the light emitted from the cold-cathode tube enters the resin material 14 through the surface (side face) of the vertical wall 54, reflected on the taper portion 56 and irradiated through the backside of the resin material 14 in a planar form.

When the resin material 14 after molding is used for a light guide plate, the taper portion 56 has a tilt angle θ3 of preferably 3 to 20 degrees.

When the resin material 14 after molding is used for a light guide plate, another form other than the above forms may also be used. For example, while the resin material 14 in FIG. 2 has a V-groove 50 having a V-shaped cross section, cross sections other than that, e.g., a rectangular, trapezoidal, circular arc or parabolic cross section may also be adopted as long as optical properties and moldability are satisfied.

Further, projections and depressions on the surface of the emboss roller 16 may not be opposite from the surface shape of the resin material 14 in FIG. 2 or FIG. 3. In view of the shrinkage allowance of the resin material 14, projections and depressions may be an offset form of those shown in FIG. 2 or FIG. 3 so that the produced resin material 14 has the shape shown in FIG. 2 or FIG. 3.

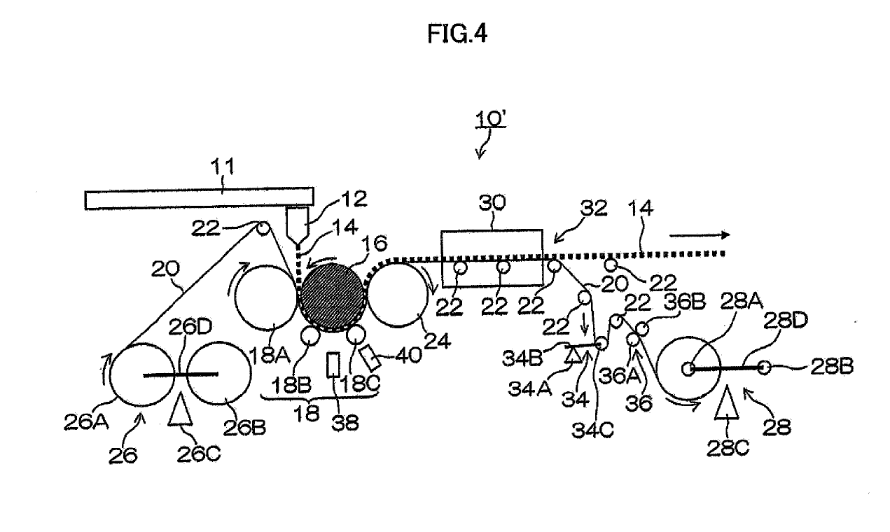

Another embodiment (second embodiment) of the method of producing a resin sheet of the present invention is now described in detail. FIG. 4 is a structural view illustrating production line 10′ for a resin sheet to which the method of producing a resin sheet of the present invention is applied. The members which are the same as or similar to those used in the first embodiment shown in FIG. 1 are denoted by the same symbols, and the description thereof is omitted.

In this embodiment, a plurality of nip rollers 18, i.e., three rollers (nip roller 18A, nip roller 18B and nip roller 18C) are used instead of one nip roller 18 in the first embodiment.

In the production line 10′ for a resin sheet, the nip roller 18A is positioned at 9 o'clock in the clockwise direction, the nip roller 18B is positioned at 7 o'clock in the clockwise direction, and the nip roller 18C is positioned at 5 o'clock in the clockwise direction. These rollers have a function substantially the same as that of the nip roller 18 in the first embodiment.

However, because three rollers are used, the distance for pressing can be extended, and therefore this configuration makes it easier to obtain the desired cross-sectional shape. Further, by driving the nip roller 18A, the nip roller 18B and the nip roller 18C individually, operation with so-called draw control becomes possible.

When a driving device is attached to the nip rollers 18 (18A, 18B and 18C), a configuration in which the driving speed of each roll is variable may be preferably adopted. With this configuration, operation in which the speed of the nip rollers 18A, 18B, 18C is gradually increased (by a few percent at most) in that order to be higher than the peripheral speed of the emboss roller 16 can be adopted.

The nip rollers 18A, 18B, 18C are all equipped with a pressurizing device (not shown) so as to press the resin material 14 present between the nip rollers and the emboss roller 16 at a pre-determined pressure. This pressurizing device applies pressure in the direction of the normal line at the contact points of the nip rollers 18A, 18B, 18C and the emboss roller 16, and various known device such as a motor driving device, an air cylinder or a hydraulic cylinder may be used.

Further, cooling devices 38, 40 are disposed in the production line 10′ for a resin sheet shown in FIG. 4, assisting the temperature control device in the nip rollers 18A, 18B and 18C.

The cooling devices 38, 40 are both composed of an air nozzle. The air nozzle of the cooling device 38 is positioned so as to spray air to the laminate of the resin material 14 and the backup sheet 20 which is being transferred, through the gap between the nip roller 18B and nip roller 18C. The air nozzle of the cooling device 40 is positioned so as to spray air to the nip roller 18C. While the temperature of the resin material 14 (laminate) is directly controlled as described above, the temperature of the resin material 14 (laminate) is also controllable by means of the nip roller 18C.

Optimal air temperature and air supply amount (spray amount) in the cooling devices 38, 40 should be determined based on the kind of the resin material 14, the temperature of the resin material 14 upon melting (e.g. at the slit exit of the die 12), the transfer speed of the resin material 14, the outer diameter of the emboss roller 16, the projection and depression pattern of the emboss roller 16 and the preset temperatures of the nip rollers (nip roller 18A, nip roller 18B and nip roller 18C).

On the other hand, for driving the nip rollers (nip roller 18A, nip roller 18B and nip roller 18C), they are operated based on so-called draw control in which the speed of the nip rollers 18A, 18B, 18C is gradually increased in that order to be higher than the peripheral speed of the emboss roller 16. The draw value for the nip rollers 18A, 18B, 18C is preferably 0 to 3%, more preferably 0 to 1%.

The method of producing a resin sheet on the production line 10′ for a resin sheet shown in FIG. 4 is now described.

A laminate of the sheet-shaped resin material 14 extruded from the die 12 and the backup sheet 20 fed from the sheet feeding device 26 and supplied on the backside of the resin material 14 is pressed by the emboss roller 16 and the nip rollers 18A, 18B, 18C in sequence, which are positioned against the emboss roller 16, thereby transferring projections and depressions on the surface of the emboss roller 16 to the resin material 14, and the laminate of the resin material 14 and the backup sheet 20 is wound on the releasing roller 24 positioned against the emboss roller 16 to be released from the emboss roller 16.

In the production of the resin sheet, the extrusion rate of the resin material 14 from the die 12 is 0.1 to 50 m/minute, preferably 0.3 to 30 m/minute. Accordingly, the peripheral speed of the emboss roller 16 is substantially consistent with the above rate.

On the other hand, for driving the nip rollers (nip roller 18A, nip roller 18B and nip roller 18C), they are operated based on so-called draw control in which the speed of the nip rollers 18A, 18B, 18C is gradually increased in that order to be higher than the peripheral speed of the emboss roller 16. The draw value for the nip rollers 18A, 18B, 18C is preferably 0 to 3%, more preferably 0 to 1%.

It is preferred that the fluctuation in the rate of the rollers is controlled to within 1% relative to the preset value.

The pressure from the nip rollers 18 (nip roller 18A, nip roller 18B and nip roller 18C) applied to the emboss roller 16 is preferably 0 to 200 kN/m (0 to 200 kgf/cm), more preferably 0 to 100 kN/m (0 to 100 kgf/cm) on a line pressure basis (value converted assuming the plane contact of nip rollers due to elastic deformation to be line contact).

It is preferred that the temperature of the nip rollers 18A, 18B, 18C and the releasing roller 24 is individually controlled. It is also preferred that the temperature of the resin material 14 on the releasing roller 24 is not higher than the softening point Ta of the resin. When polymethyl methacrylate resin is used as the resin material 14, the preset temperature of the releasing roller 24 may be 50 to 110° C.

The resin material 14 released from the emboss roller 16 is transferred in the horizontal direction, gradually cooled while passing through the gradual cooling zone 30, and when strain is removed, the resin material 14 is cut into a pre-determined length and stored as resin sheet products in a product collecting zone in the downstream.

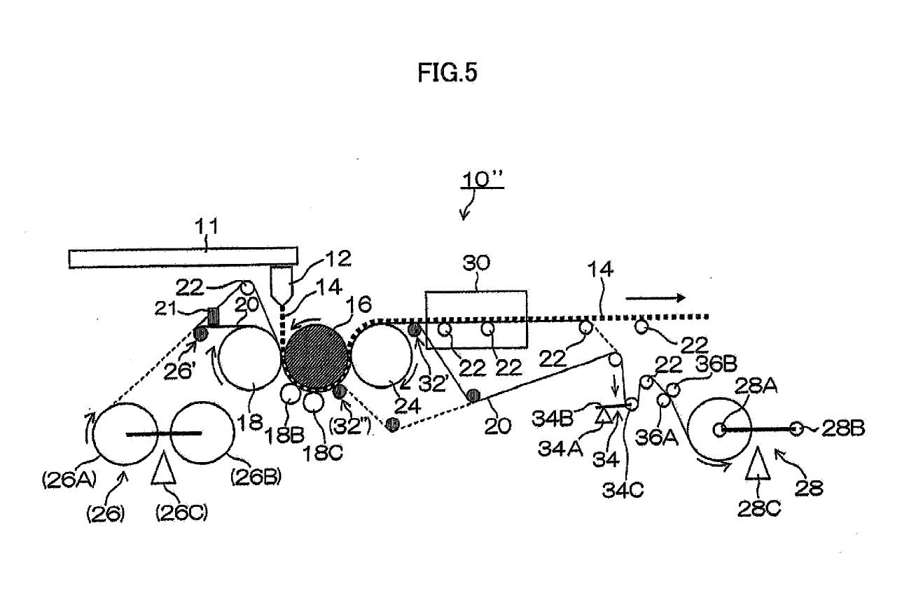

Next, still another embodiment (third embodiment) of the method of producing a resin sheet of the present invention is described. FIG. 5 is a structural view illustrating production line 10″ for a resin sheet to which the method of producing a resin sheet of the present invention is applied. The members which are the same as or similar to those used in the first embodiment shown in FIG. 1 and the second embodiment shown in FIG. 4 are denoted by the same symbols, and the description thereof is omitted.

In this embodiment, instead of the sheet feeding device 26 in the first and the second embodiments, a sheet feeding device 26′ is disposed immediately before the nip roller 18. The backup sheet 20 fed from the sheet feeding device 26′ is heated by a pre-heating device 21 disposed adjacent thereto.

When such a configuration is employed, adhesiveness between the backup sheet 20 and the resin material 14 can be improved. In addition, the amount of displacement can be decreased by reducing the difference in heat shrinkage between the backup sheet 20 and the resin material 14. Further, curl of the backup sheet 20 can be reduced.

Further, unlike the first and the second embodiments, a peeling part 32′ is disposed in the upstream of the gradual cooling zone 30.

This production line 10″ for a resin sheet is also capable of producing good products depending on the line conditions and the kind of the resin material 14.

Further, as described by a fictitious line in FIG. 5, a configuration in which a peeling part 32″ is disposed in the upstream of the releasing roller 24 is also adoptable.

According to the method of producing a resin sheet of the present invention described above (first to third embodiments), the desired cross-sectional shape can be obtained even in the case of a resin sheet with a wide thickness distribution in the width direction upon molding.

While embodiments of the method of producing a resin sheet of the present invention have been described above, the present invention is not limited to the above-described embodiments and various modes are available.

For example, various modes other than the present embodiments are available for the number and the position of nip rollers as long as similar function is obtained.

Further, various modes other than the present embodiments are available for the temperature control device, the cooling device (such as the cooling device 38) and the gradual cooling zone 30 as well, as long as similar function is obtained.

1-10. (canceled)

11. A method of producing a resin sheet, comprising the steps of:
pressing a sheet-shaped resin material extruded from a die and a backup sheet fed to one side of the resin material by an emboss roller and a nip roller positioned against the emboss roller in such a manner that the resin material is on the side of the emboss roller and the backup sheet is on the side of the nip roller,
transferring projections and depressions on the surface of the emboss roller to the resin material, and
winding a laminate of the resin material and the backup sheet after transfer on a releasing roller positioned against the emboss roller to release the laminate from the emboss roller.

12. The method of producing a resin sheet according to claim 11, wherein the projections and depressions transferred to the resin material create a difference in thickness in the width direction between the thickest part and the thinnest part of the resin material of 1 mm or more.

13. The method of producing a resin sheet according to claim 11, wherein the resin material has a thickness of 5 mm or less at the thinnest part.

14. The method of producing a resin sheet according to claim 12, wherein the resin material has a thickness of 5 mm or less at the thinnest part.

15. The method of producing a resin sheet according to claim 11, wherein the backup sheet is a resin sheet having a glass transition temperature Tg₁ which is higher than the glass transition temperature Tg₂ of the resin material.

16. The method of producing a resin sheet according to claim 13, wherein the backup sheet is a resin sheet having a glass transition temperature Tg₁ which is higher than the glass transition temperature Tg₂ of the resin material.

17. The method of producing a resin sheet according to claim 11, wherein the backup sheet has a modulus of longitudinal elasticity of 1×10⁹ N/m² or more when used.

18. The method of producing a resin sheet according to claim 16, wherein the backup sheet has a modulus of longitudinal elasticity of 1×10⁹ N/m² or more when used.

19. The method of producing a resin sheet according to claim 11, wherein the backup sheet has a thickness of 0.01 to 1.0 mm.

20. The method of producing a resin sheet according to claim 18, wherein the backup sheet has a thickness of 0.01 to 1.0 mm.

21. The method of producing a resin sheet according to claim 11, further comprising: peeling off the backup sheet from the resin material after releasing the laminate of the resin material and the backup sheet after transfer from the emboss roller, or on the emboss roller.

22. The method of producing a resin sheet according to claim 20, further comprising: peeling off the backup sheet from the resin material after releasing the laminate of the resin material and the backup sheet after transfer from the emboss roller, or on the emboss roller.

23. The method of producing a resin sheet according to claim 21, further comprising: cleaning the backup sheet peeled off from the resin material.

24. The method of producing a resin sheet according to claim 22, further comprising: cleaning the backup sheet peeled off from the resin material.

25. The method of producing a resin sheet according to claim 11, further comprising: disposing a sheet feeding device for continuously feeding the backup sheet and a sheet winding device for accepting the backup sheet.

26. The method of producing a resin sheet according to claim 24, further comprising: disposing a sheet feeding device for continuously feeding the backup sheet and a sheet winding device for accepting the backup sheet.

27. The method of producing a resin sheet according to claim 11, wherein the backup sheet has projections and depressions on substantially the entire surface contacting the resin material and the projections and depressions are transferred to the resin material.

28. The method of producing a resin sheet according to claim 25, wherein the backup sheet has projections and depressions on substantially the entire surface contacting the resin material and the projections and depressions are transferred to the resin material.
